(19) United States
(12) Patent Application Publication
(10) Pub. No.: US 2013/0287994 A1
(43) Pub. Date: Oct. 31, 2013

(54) SANDWICH PANEL HAVING A TRANSVERSE BEAM AND METHOD FOR PRODUCING THE SAME

(71) Applicant: Biessler Dietmar, Hamburg (DE)

(72) Inventor: Biessler Dietmar, Hamburg (DE)

(73) Assignees: AR-K S.A.S, Bogota (CO); DEUTSCHE COMPOSITE GMBH, Lauenburg/Elbe (DE)

(21) Appl. No.: 13/883,905

(22) PCT Filed: Nov. 8, 2011
(86) PCT No.: PCT/EP2011/005593

§ 371 Date: Jul. 22, 2013

(30) Foreign Application Priority Data
Nov. 8, 2010 (EP) 10014365.0

(51) Int. Cl. B32B 37/16; E04C 2/36

(52) U.S. Cl. CPC B32B 37/16; E04C 2/36
USPC 428/119; 156/60

(57) ABSTRACT

The invention relates to a method for producing a sandwich panel made of at least one cover layer (26, 28) to be laminated and at least one core layer material block (8, 8′, 10, 10′, 12, 12′, 14, 14′), characterized by the step of: arranging a core layer material block and a transverse beam (4, 16, 18) made of a previously laminated panel, such that a surface of the core layer material block and an edge of the transverse beam form an area that can be jointly laminated for the cover layer to be laminated and such that the transverse beam is at an angle to the area that can be laminated, and by the following step: laminating the area that can be laminated, so that resin produces a bond between the surface of the core layer material block and the edge of the transverse beam on one side and the cover layer to be laminated on the other side.

The present invention relates to a sandwich panel made of at least one laminated cover layer and at least one core layer material block as well as a method for producing such a sandwich panel.

Sandwich panels are a widespread building and construction material. Conceptually, they combine flat material that consists of at least two layers.

Sandwich panels made of a relatively voluminous core layer with respectively one cover layer on both sides of the core layer are widespread. In order to give for example a sandwich panel both thermally insulating as well as mechanical load-bearing properties, a typical sandwich panel is made of a core layer from light, dimensionally stable plastic foam and cover layers on both sides for example made of glass-fibre reinforced plastic laminate or carbon-fibre reinforced plastic laminate. Glass-fibre reinforced plastic (GFRP) and carbon-fibre reinforced plastic (CFRP) is made as is generally known of glass-fibre or respectively carbon-fibre fabric mats (as fibre reinforcement), which are placed on the surface to be laminated (here the one core layer material block made of plastic foam) in one or more layers on top of each other and are saturated (coated and/or doused) with plastic, for example epoxy resin or polyester resin with hardener, preferably including flame protection (as a so-called matrix).

The object of the present invention is to create a sandwich panel, which has even better rigidity and strength properties.

According to the invention, this object is achieved by means of a method with the characteristics of claim 1 as well as through a sandwich panel with the characteristics of claim 7. Preferred embodiments are specified in the respective dependent claims.

In the method according to the invention, a sandwich panel is made of at least one core layer material block and at least one cover layer for example made of GFRP laminate or CFRP laminate, which is laminated onto the material block. According to the invention, the method comprises the step of arranging at least one core layer material block as well a transverse beam made of a previously laminated panel such that a surface of the core layer material block and an edge of the transverse beam lie in an area that is jointly laminatable (“form a jointly laminatable area for the cover layer to be laminated”). The transverse beam thereby lies at an angle to the laminatable area—thus, not plane-parallel to it.

According to the invention, the method then further comprises the step of laminating the laminatable area (in which the surface of the core layer material block and the edge of the transverse beam lie) such that resin establishes a bond between the surface of the core layer material block and the edge of the transverse beam on the one hand and the cover layer to be laminated on the other hand. At least in one region, i.e. where the edge of the transverse beam lies in the laminatable area, the resin of the laminated cover layer establishes a bond between the surface of the core layer material block and the edge of the transverse beam on the one hand and the cover layer to be laminated on the other hand.

According to the invention, a sandwich panel is also of the design that results from the production according to the invention.

Thus, according to the invention, sandwich panels (in particular of the initially named exemplary design with a light, dimensionally stable core layer and load-bearing laminate outer layers) are equipped with additional bending stiffness and torsional stiffness, in that at least one transverse beam from a previously laminated panel is laminated into the core layer.

A transverse beam made of a previously laminated panel means, according to the invention, that a panel is produced through lamination and is then processed into a sandwich panel according to the invention. A panel does not necessarily have to be flat. Rather, the transverse beam according to the invention can also be curved and/or arched but also even zigzagged or wavy, for example. A panel can be produced through lamination in the sense according to the invention in that one or several glass-fibre or carbon-fibre fabric mats are laid out on an even underground (or on an underground according to the just suggested potential spatial design) and saturated, coated and/or doused with plastic such as for example epoxy resin. After the hardening of the resin, the panel laminated in this manner is removed from the underground. For this, the underground can be provided with a release agent in order to facilitate removal. If necessary, the panel will now be cut.

The method according to the invention for producing a panel according to the invention is preferably executed as follows: A core layer material block is placed next to a transverse beam made of a previously laminated panel. This happens preferably in a flush manner, that is, a (preferably flat) transverse beam is put flush against an (then preferably flat) outer surface (side surface, abutting surface) of the core layer material block. A block is again preferably put against the other side of the transverse beam, against this another transverse beam and so forth, for example until the length of the sandwich panel to be produced has been reached. These elements placed next to each other form the core layer of the sandwich panel to be produced. A few of the transverse beams are thereby preferably oriented such that the length, in which they were produced (for example cut from a previously laminated large panel), is now oriented as the height—that is vertically. The core layer material blocks put against these transverse beams then have a corresponding height and a vertical side surface, which rests flush against the vertically oriented transverse beam. Other transverse beams can thereby be oriented such that the length, in which they were produced (for example cut from a previously laminated large panel), is now oriented as the diagonal—that is for example less than 45°. The core layer material blocks put against these transverse beams are then correspondingly diagonally cut and have a corresponding (for example 45°) diagonal side surface, which rests flush against the vertically oriented transverse beam. The edges of these laid out components of the core layer are preferably aligned straight with respect to each other (or, also cut later). In the next step, a cover layer for example made of GFRP laminate or CFRP laminate is now laminated onto a common outside of these flushly interconnecting core layer components (the outside of the top sides of the core layer material blocks and the upper edges of the transverse beams) such that resin of the laminated cover layer establishes a bond between the surface of the respective core layer material block and the edge of the transverse beam on the one hand and the cover layer to be laminated on the other hand. After this cover layer has dried, this arrangement is reversed and the lamination of the cover layer is repeated on its bottom side: a cover layer for example made of GFRP laminate or CFRP laminate is laminated onto the outside of these flushly interconnecting core layer components (the outside of the previous bottom sides of the core layer material block and the previous bottom edges of the transverse beams) such that resin of the laminated cover layer establishes a bond between the surface of the respective core layer material block and the edge of the transverse beam on the one hand and the cover layer to be laminated on the other hand.

Due to the geometric clearness and simplicity and the resulting economic producibility (also due to the relatively large demand for flat sandwich panels) it is particularly preferred to produce a flat sandwich panel with a top-side and bottom-side cover layer out of a cuboidal core layer material block material (or at least with a flat, plane-parallel top side and bottom side). But also all other spatial designs with curved and/or arched elements with the characteristics of one of the two independent claims are possible according to the invention.

These and other characteristics and advantages of the present invention are explained further based on exemplary embodiments in the accompanying illustrations.

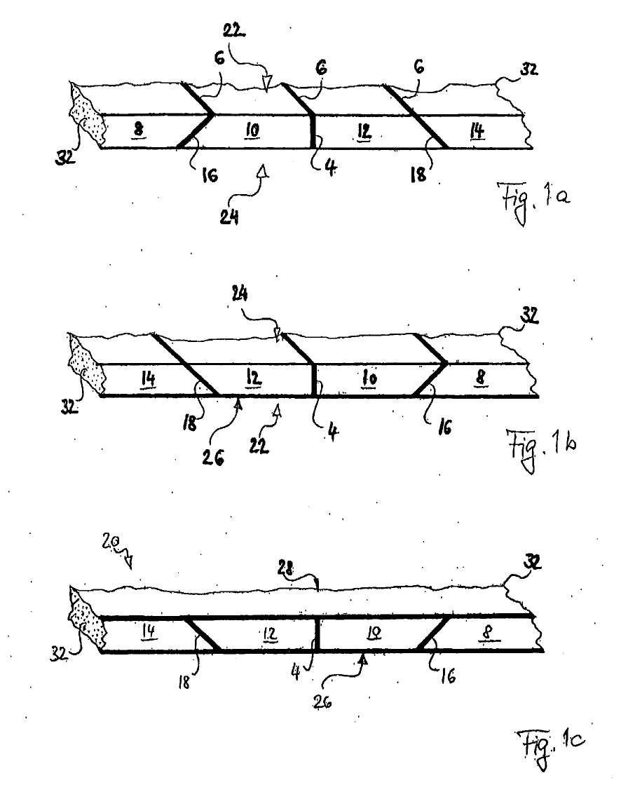

FIG. 1 shows spatially and schematically the production according to the invention of a sandwich panel according to the invention in three stages,

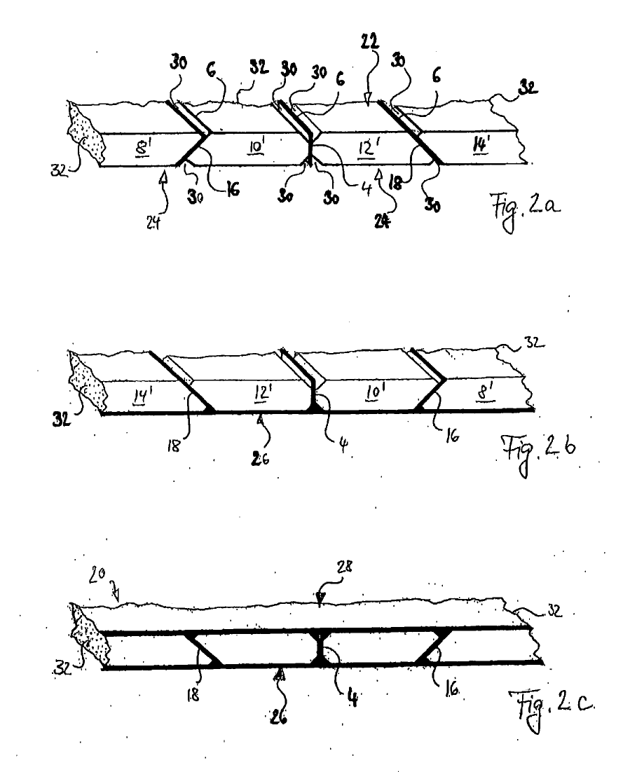

FIG. 2 shows spatially and schematically an alternative to FIG. 1 also in three stages,

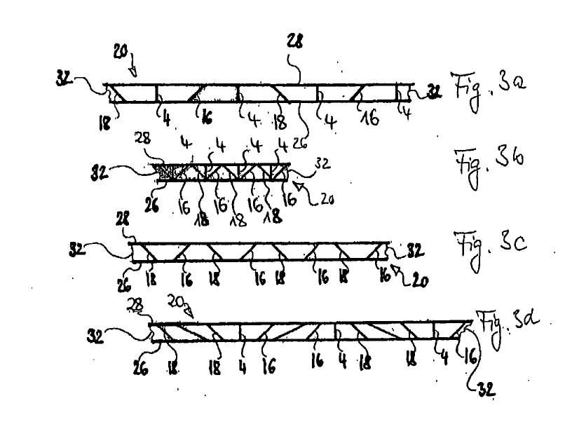

FIG. 3 shows a side view of four different sandwich panels according to the invention,

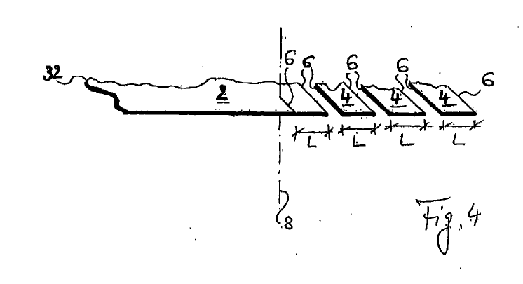

FIG. 4 shows spatially and schematically the cutting of transverse beams according to the invention made of a previously laminated panel and

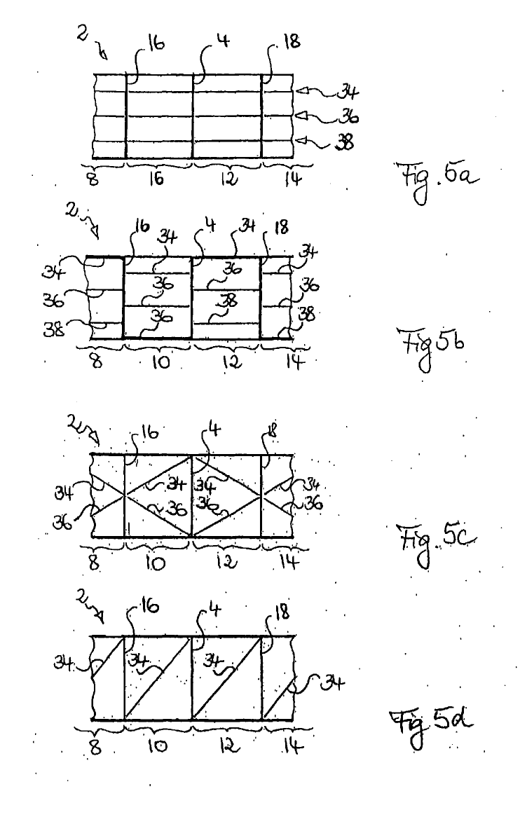

FIG. 5 shows a top view of four different alternative sandwich panels according to the invention.

First, looking at FIG. 4, it can be seen how transverse beams 4 are cut from a previously laminated panel 2, for example made of fibre-reinforced plastic. The transverse beams 4 are cut off the panel in a length L. In other words, the parallel cut edges 6 of the transverse beams 4 have the distance L from each other. The transverse beams 4 are cut for example by means of a band saw or a circular saw. The cutting tool is only indicated schematically in FIG. 4 by a dashed-and-dotted line 8.

FIG. 1a shows four core layer material blocks 8, 10, 12, 14, which are arranged flush against each other alternating respectively with a transverse beam 16, 4, 18 as the core layer of a sandwich panel 20 to be produced (FIG. 1c).

The core layer material blocks each have a top side 22 and a bottom side 24, which are parallel to each other. The transverse beams 4, 16 and 18 are flat. They are (with their respective top or respectively bottom side) put flush against a respective flat outer surface of one of the material blocks. The transverse beam 4 is oriented such that its length L, in which it was cut from the previously laminated large panel 2 according to FIG. 4, is now oriented as the height—that is vertically in FIG. 1a. The laid out material blocks 8, 10, 12, 14 have a corresponding height, that is a distance L between its top side 22 and its plane-parallel bottom side 24. As can be seen, the transverse beams 16 and 18 are oriented diagonally by less than 45° to the top side 22 and the bottom side 24. These two transverse beams 16 and 18 have a greater length (L times the square root of 2) so that their respective upper edge 6 with the top side of the material blocks and their respective bottom edge with the bottom side of the material blocks form a flat, jointly laminatable area.

In the next step, a cover layer 26 (FIG. 1b) is now laminated onto the jointly laminatable area on the top side 22 of these flushly adjoining core layer components 8, 16, 10, 4, 12, 18, 14. After this core layer 26 has dried, the arrangement is reversed. The arrangement according to Figure lb then results. The previous bottom side 24 is now visible as the flat, jointly laminatable area 24—(now) on the top side of the thus arranged core layer elements (from left to right 14, 18, 12, 4, 10, 16, 8). This flat area 24 to be laminated is now also laminated with a cover layer 28 (FIG. 1c) and left to dry. The finished sandwich panel 20 according to FIG. 1c is thus created.

As can be seen in particular in FIG. 1c, the lamination of the two cover layers 26, 28 took place such that resin of the laminated cover layer establishes a bond between the laminated cover layer 26, 28 on the one hand and the surfaces of the respective core layer material block on the other hand (on both of their sides 22 and 24)—and such that the resin also establishes a bond between the laminated cover layer 26, 28 on the one hand and the edges 6 of the transverse beams 16, 4, 18 on the other hand. In order to enable this according to the invention, the edges 6 of the transverse beams 16, 4, 18 lie in one area—here even in one plane—with outsides of the core layer material block (here on its one side 22 and the other side 24 lying plane-parallel with respect to it). Thus, for example according to FIG. 1a, the top sides 22 of the core layer material blocks 8, 10, 12, 14 together with the top edges 6 of the transverse beams 16, 4, 18 form, as already mentioned, a jointly laminatable area for the cover layer to be laminated (which has the reference number 26 after reversal according to FIG. 1b).

The bond between the edges 6 of the transverse beams 16, 4, 18 and the respective laminated areas 26, 28 results due to the fact that the resin establishes a bond with the edge during the lamination of the cover layers. For this, it is particularly advantageous if the transverse beams were made of the same laminate as the cover layers. At least the use of the same resin is advantageous if transverse beams and cover layer were made for example of fibre-reinforced plastic (GFRP or CFRP; epoxy or polyester).

As described so far for FIG. 1, a sandwich panel is created, which is shown again in a side view in FIG. 3a. The sandwich panel 20 namely has two plane-parallel cover layers 26, 28 as well as transverse beams connecting the two cover layers at an even spacing from left to right: vertical transverse beams 4 between which transverse beams are located running diagonally by less than 45°, of which, in an alternating manner, one transverse beam 16 is oriented sloping by less than 45° to the left and one transverse beam 18 is oriented sloping by less than 45° to the right. The transverse beams 18, 4, 16, 4, 18, 4, 16, 4 etc. are thereby spaced apart to the extent that they do not touch each other. This is different in an alternative embodiment of a sandwich panel according to FIG. 3b: a transverse beam 18 sloping diagonally to the right, a vertical transverse beam 4 and a transverse beam 16 sloping diagonally to the left always meet here with their bottom edge at the bottom cover layer 26, and one of the transverse beams 18 and one of the transverse beams 16 meet at the top cover layer 28 (also from left to right).

FIG. 3c is still an alternative embodiment of a sandwich panel, in which there are no vertical transverse beams 4 used, but rather only transverse beams 16, 18 diagonally oriented by less than 45° in both directions. FIG. 3d finally shows a side view of a sandwich panel with transverse beams oriented not just vertically and by less than 45°, but also at a different angle. As a whole, FIG. 3 is intended to show that the distance and orientation of the transverse beams can be designed in any manner in the sandwich panel according to the invention.

Returning for a moment to FIG. 1, each of the blocks 8, 10, 12, 14 in Figure la can already have at least one cover layer laminated onto its top side 22 and/or bottom side 24 in particular if each of the blocks 8, 10, 12, 14 has already been crossed by transverse beams (FIG. 5; not shown in FIG. 1), and namely in the manner according to the invention, as described for example above for FIG. 1. These already existing transverse beams could then for example run at a right angle to the transverse beams 16, 4, 18 now to be laminated according to FIG. 1 already through each of the blocks 8, 10, 12, 14 in Figure la (from right to left in Figure I a). Through the re-lamination with the cover layers 26, 28 to be laminated, a sandwich panel with transverse beams 18, 4, 16 and longitudinal beams 34, 36, 38 is then created, for example according to FIG. 5a or 5b. But, the transverse and longitudinal beams can also be oriented not at a right angle to each other (for example according to FIG. 5c or 5d), and the longitudinal beams also do not need to be oriented at a right angle to the cover layers 26, 28 (not shown). This (in the plan view of the panels 2 also half-timbered-like) orientation of the longitudinal and transverse beams is offered for example in the case of transport- and/or production-related large, prefabricated, elongated sandwich panels 2—for example with widths of approx. 2.5 m (in FIG. 5 from top to bottom) and lengths of approx. 12 m (in FIG. 5 from right to left), in which the penetrating beams 16, 4, 18 then preferably run in the direction of the width.

FIG. 2 shows a modification—or rather an enhancement—of the method described thus far: in the form of gaps 30 where the respective transverse beam ends at the area to be laminated. It can namely be seen in FIG. 2 that each of the material blocks 8′, 10′, 12′ and 14′ has a chamfer of 45° there along the edges 6 of the respective transverse beams 16, 4 and 18—that is generally an area where material volume was removed from the material block to form the gap 30. Such gaps are generally the object of a second patent application, which has been submitted at the same time as this application.

Looking at FIG. 2b, it can be seen that the gap, where the cover layer 26 is already laminated, was filled with resin during its lamination. Thus, a bond forms there between the respective transverse beam and the laminated cover layer, which is considerably larger in area than the corresponding bonds according to FIG. 1. Shear and torsional stresses in particular during bending and/or torsional loading of the panel are transferred according to the invention at these larger edges of the transverse beams connected with the cover layers 26, 28 through a larger cross-section preferably also changing its direction less abruptly. This advantageously reduces material stress and failure potentially resulting from it.

It is also noted that, in all FIGS. 1 through 4, breaking edges 32 indicate that the respectively shown element extends further in this direction. It is also noted that elements with the same numbers have the same design in the figures.

1. A method for producing a sandwich panel from at least one cover layer to be laminated and
at least one core layer material block characterised by the step of:
arranging a core layer material block and a transverse beam made of a previously laminated panel such that a surface of the core layer material block and an edge of the transverse beam form a jointly laminatable area for the cover layer to be laminated and that the transverse beam lies at an angle to the laminatable area, and by the subsequent step of:
laminating the laminatable area such that resin establishes a bond between the surface of the core layer material block and the edge of the transverse beam on the one hand and the cover layer to be laminated on the other hand.

2. The method according to claim 1, characterised in that the arrangement takes place such that the transverse beam is put flush against an outer surface of the core layer material block.

3. The method according to claim 1, characterised in that the surface [and the outer surface] of the core layer material as well as of the transverse beam are flat.

4. The method according to claim 1, characterised in that the transverse beam forms an angle (impact angle) of 45° to 90°, in particular of 45° or 90° +/−5° to the area to be laminated where the transverse beam ends at the area to be laminated.

5. The method according to claim 1, characterised in that along the jointly laminatable area several core layer material blocks and several transverse beams are arranged in an alternating order, wherein the impact angle of a transverse beam is 30° to 60°, in particular 45° +/−5° and the impact angle of another transverse beam, in particular of the next or next but one transverse beam of the order, is 120° to 150°, in particular 135° +/−5°.

6. The method according to one of the preceding claims claim 1, characterised by the step temporally before the arrangement of the transverse beam being cut off as a section of a previously laminated panel.

7. A sandwich panel made of at least one laminated cover layer and at least one core layer material block characterised in that
the laminated cover layer is laminated on a jointly laminatable area, which consists of a surface of the core layer material block and an edge of a transverse beam made of a previously laminated panel and
that the transverse beam lies at an angle to the laminated cover layer and
that at least in one area, where the edge of the transverse beam lies in the laminatable area, the resin of the laminated cover layer establishes a bond between the surface of the core layer material block and the edge of the transverse beam on the one hand and the cover layer to be laminated on the other hand.

8. The sandwich panel according to claim 7, characterised in that the transverse beam rests flush against an outer surface of the core layer material block.

9. The sandwich panel according to claim 7, characterised in that the surface [and the outer surface] of the core layer material block as well as of the transverse beam are flat.

10. The sandwich panel according to claim 7, characterised in that the transverse beam forms an angle (impact angle) of 45° to 90°, in particular of 45° or 90° +/−5° to the laminated area there where the transverse beam ends at the laminated area.

11. The sandwich panel according to one of the four preceding claims claim 7, characterised in that along the laminated area several core layer material blocks and several transverse beams are arranged in an alternating order, wherein the impact angle of a transverse beam is 30° to 60°, in particular 45° +/−5° and the impact angle of another transverse beam, in particular of the next or next but one transverse beam of the order, is 120° to 150°, in particular 135° +/−5°.

12. The sandwich panel according to one of the preceding claims claim 7, characterised in that the transverse beam is a section of a previously laminated panel.
